(19) United States
(12) Patent Application Publication
(10) Pub. No.: US 2016/0132792 A1
(43) Pub. Date: May 12, 2016

(54) SYSTEMS AND METHODS FOR FACILITATING TRANSPORTATION TRANSACTIONS

(71) Applicant: Carzac. Inc., Walnut Creek, CA (US)

(72) Inventor: David ROSNOW, Walnut Creek, CA (US)

(73) Assignee: CARZAC, INC., Walnut Creek, CA (US)

(21) Appl. No.: 14/937,646

(22) Filed: Nov. 10, 2015

Related U.S. Application Data
(60) Provisional application No. 62/077,692, filed on Nov. 10, 2014.

(51) Int. Cl. G06Q 10/02; G06F 3/0484; G06F 3/0482

(52) U.S. Cl. CPC G06Q 10/02; G06F 3/0482; G06F 3/0484

(57) ABSTRACT

Systems and methods for facilitating transportation transactions are described. The techniques describe herein may enable users to participate in ride-sharing. Applications may be provide that present graphical user interfaces that enable a user to complete ride-sharing transactions.

### RELATED APPLICATIONS

This application claims the benefit of U.S. Provisional Application No. 62/077,692, filed on Nov. 10, 2014, which is incorporated by reference in its entirety.

### TECHNICAL FIELD

This disclosure relates to transportation transactions, and more particularly, to techniques for facilitating transactions between drivers and riders.

### BACKGROUND

Increasing vehicle occupancy is a long sought public policy goal, yet over the last few decades, despite public campaigns to promote ride-sharing, vehicle occupancy has gradually declined. The decline of vehicle occupancy is a serious problem because as vehicle occupancy declines, moving the same number of people results in more traffic, generates more pollution, and requires more natural resources.

Current techniques may increase vehicle occupancy by attempting to facilitate ride-sharing transactions. Current techniques for attempting to facilitate ride-sharing transactions may be less than ideal.

### SUMMARY

In general this disclosure describes techniques for facilitating transactions between drivers and riders. In particular, this disclosure describes example techniques for enabling users to offer and accept a ride-share. In one example, the system for enabling transactions described herein is based on known meeting places. In one example, systems described herein may be configured to provide a user with an application. The application may be configured to provide one or more graphical user interfaces to a user. Graphical user interfaces may enable a user to provide origin information, destination information, and schedule information. Graphical user interfaces may provide a user with a list of possible routes, wherein each of the possible routes are associated with one or more of: an origin place, a destination place, an origin place popularity, a destination place popularity, an origin place type, a destination place type, a route popularity, and another user. It should be noted that although the examples described herein relate to ride-sharing for cars, the techniques may be more generally applied to other types of transportation. For example, the system and techniques described herein may be used with respect to other modes of transportation, including, for example, bus rides, train rides, and flights. Further, it should be noted that although the example techniques described herein are described with respect to a user commuting from home to work, the techniques described herein may be generally applicable to any types of locations (e.g., travel from an event center to hotel, etc.).

According to one example of the disclosure, a method of facilitating a transportation transaction comprises providing a graphical user interface enabling a user to provide origin information, providing a graphical user interface enabling a user to provide destination information, providing a graphical user interface enabling a user to provide schedule information, and providing a graphical user interface including a list of routes based on origin information, destination information and schedule information, wherein each of the routes are associated with a number of available rides.

According to another example of the disclosure, a device comprises one or more processors configured to provide a graphical user interface enabling a user to provide origin information, provide a graphical user interface enabling a user to provide destination information, provide a graphical user interface enabling a user to provide schedule information, and provide a graphical user interface including a list of routes based on origin information, destination information and schedule information, wherein each of the routes are associated with a number of available rides.

According to another example of the disclosure, a non-transitory computer-readable storage medium has instructions stored thereon that upon execution cause one or more processors of a device to provide a graphical user interface enabling a user to provide origin information, provide a graphical user interface enabling a user to provide destination information, provide a graphical user interface enabling a user to provide schedule information, and provide a graphical user interface including a list of routes based on origin information, destination information and schedule information, wherein each of the routes are associated with a number of available rides.

According to another example of the disclosure, an apparatus comprises means for providing a graphical user interface enabling a user to provide origin information, means for providing a graphical user interface enabling a user to provide destination information, means for providing a graphical user interface enabling a user to provide schedule information, and means for providing a graphical user interface including a list of routes based on origin information, destination information and schedule information, wherein each of the routes are associated with a number of available rides.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example system that may implement one or more techniques of this disclosure.

FIG. 2 is a block diagram illustrating an example of a computing device that may implement one or more techniques of this disclosure.

FIG. 3 is conceptual diagram illustrating potential transactions according to one or more techniques of this disclosure.

FIGS. 4A-4B are conceptual diagrams illustrating a transaction according to one or more techniques of this disclosure.

FIGS. 5A-5C are conceptual diagrams illustrating a graphical user interface that may implement one or more techniques of this disclosure.

FIG. 6 is a conceptual diagram illustrating a graphical user interface that may implement one or more techniques of this disclosure.

FIG. 7 is a conceptual diagram illustrating a graphical user interface that may implement one or more techniques of this disclosure.

FIGS. 8A-8D are conceptual diagrams illustrating a graphical user interface that may implement one or more techniques of this disclosure.

FIG. 9 is a conceptual diagram illustrating a graphical user interface that may implement one or more techniques of this disclosure.

FIG. 10 is a conceptual diagram illustrating a graphical user interface that may implement one or more techniques of this disclosure.

FIGS. 11A-11B are conceptual diagrams illustrating a graphical user interface that may implement one or more techniques of this disclosure.

FIGS. 12A-12D are conceptual diagrams illustrating a graphical user interface that may implement one or more techniques of this disclosure.

### DETAILED DESCRIPTION

This disclosure describes example techniques for facilitating transactions between drivers and riders. The techniques described herein may be implemented in devices configured to provide graphical user interfaces to a user. The graphical user interfaces may enable a user to offer and/or accept a ride-share from one or more other users.

Traditional carpool matching systems have sought to assist in carpool formation by providing commuters lists of other commuters with whom they can carpool. These systems are based on geographic matching between the respective home and work of the driver and passenger. Would-be carpoolers are then expected to review these carpool match lists and contact other carpoolers to make arrangements. The users must decide who drives, where to meet, travel times, and compensation. This process for arranging rides presents carpoolers with significant hurdles. To evaluate the carpool match-list, carpoolers must sort through the disparate origins and destinations of their fellow commuters, many of those places may be unfamiliar to the commuter. Next the carpooler must contact the other person and negotiate where and when to meet. Additionally, the carpooler, if picked-up at home has to trust the other person with his or her home address. Further, the driver must learn how to find the home of the passenger. All of these steps are hurdles to carpooling being a widely adopted mode of transportation.

In one example, the system for enabling transactions described herein is based on known meeting places. That is, rather than match a potential carpooler with another person, the system may enable matching carpoolers to known meeting places in the area around the home and work of the commuter. Examples of meeting places may include coffee shops, stores, landmarks, and transit stops, i.e., any place convenient to the users of the system. In one example, carpoolers are then matched based on the places they have in common. This may offer significant efficiencies: carpoolers who match on places and time have very little further to negotiate; drivers can pick places that are an acceptable diversion from their normal route, so picking up a rider is convenient; passengers do not have to share their home address with a stranger; and both parties get additional security from meeting in a public place.

Additionally, because places are shared by many people, plans between two parties can easily be extended to others. A ride between two known places at a given time presents immediately understandable terms for another passenger to join the ride, or for another driver to make a similar offer at the same time or another day or time. By systematizing and normalizing the process of offering to drive a carpool, the sharing of seats can become a much more commoditized activity and the transaction costs of participating in a carpool are significantly reduced. Reduced transaction costs may hopefully spur more carpooling, thereby decrease the negative effects associated with traffic congestion.

It should be noted that because the places to meet are specifically identified, offers and requests include the necessary logistical information to make the agreement to drive actionable and transactional. In one example, driver and passenger schedules are captured in a route object, which contains a template for repeated commuting. In one example, based on the route object, a system may generate offers for every combination of meeting places. Those offers may then be presented to potential riders as potential rides. Potential riders may indicate the places that are preferred to take rides and are then are presented the matching offers from drivers. Additionally, the example systems described herein can provide a geographic search to show the rider any offers that are in close proximity to planned origin and destination even if the rider did not select those places to meet.

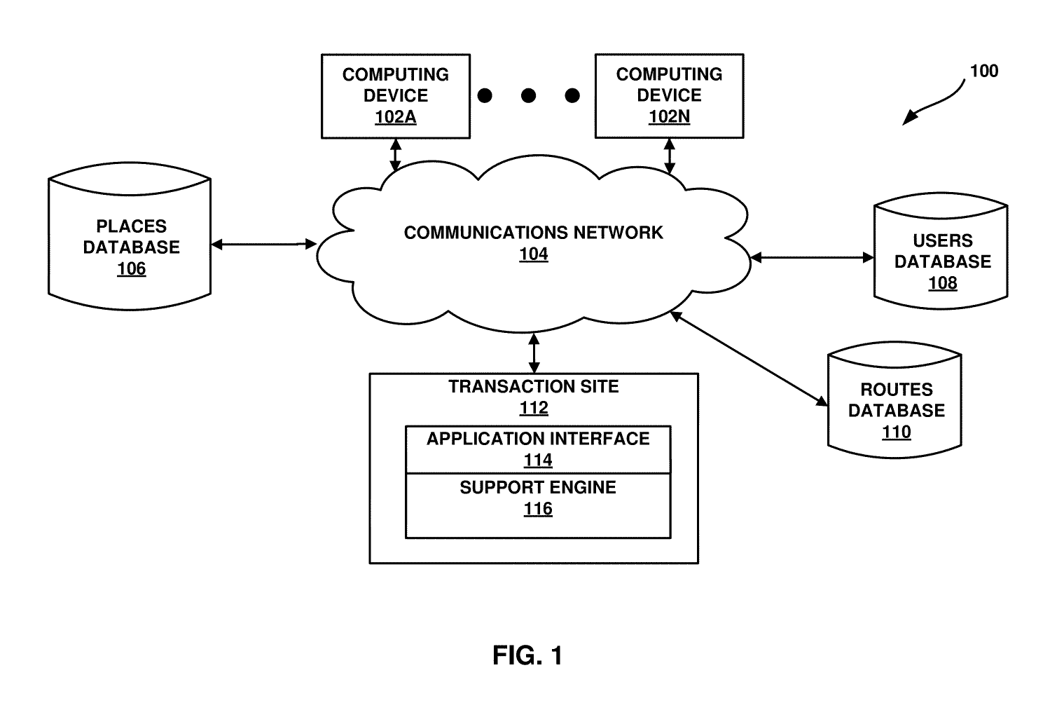

FIG. 1 is a block diagram illustrating an example system that may implement one or more techniques of this disclosure. System 100 may be configured to enable transportation transactions in accordance with the techniques described herein. In the example illustrated in FIG. 1, system 100 includes one or more computing devices 102A-102N, communications network 104, places database 106, users database 108, routes database 110, and transaction site 112. Transaction site 112 may include application interfaces 114 and support engine 116. System 100 may include software modules operating on one or more servers. Software modules may be stored in a memory and executed by a processor. Servers may include one or more processors and a plurality of internal and/or external memory devices. Examples of memory devices include file servers, network attached storage (NAS) devices, a local disk drive, or any other type of device or storage medium capable of storing data. Storage medium may include Blu-ray discs, DVDs, CD-ROMs, flash memory, or any other suitable digital storage media. When the techniques described herein are implemented partially in software, a device may store instructions for the software in a suitable, non-transitory computer-readable medium and execute the instructions in hardware using one or more processors.

System 100 represents an example of a system that may be configured to enable users of computing devices 102A-102N to initiate and complete ride-sharing transactions. Computing devices 102A-102N may include any device configured to transmit data to and receive data from communication network 104. For example, computing devices 102A-102N may be equipped for wired and/or wireless communications and may include desktop or laptop computers, mobile devices, tablet computers, smartphones, cellular telephones, set top boxes, and personal gaming devices.

Communications network 104 may comprise any combination of wireless and/or wired communication media. Communication network 104 may include routers, switches, base stations, or any other equipment that may be used to facilitate communication between various devices and sites. Communication network 104 may form part of a packet-based network, such as a local area network, a wide-area network, or a global network such as the Internet. Communication network 104 may operate according to one or more communication protocols, such as, for example, a Global System Mobile Communications (GSM) standard, a code division multiple access (CDMA) standard, a 3rd Generation Partnership Project (3GPP) standard, an Internet Protocol (IP) standard, a Wireless Application Protocol (WAP) standard, and/or an IEEE standard, such as, one or more of the 802.11 standards, as well as various combinations thereof.

As illustrated in FIG. 1, places database 106, users database 108, and routes database 110 are connected to communications network 104. Each of places database 106, users database 108, and routes database 110 may respectively include any and all combinations of the memory devices described above. Each of places database 106, users database 108, and routes database 110 may store information associated with the operation of system 100.

Places database 106 may store data associated with places. That is, potential pick-up and drop-off locations. For example, places database 106 may include a list places (e.g., coffee shops) and associated locational information (e.g., an address and/or GPS coordinates). Users database 108 may store data associated with users. For example, users database 108 may include a profile for each user of system 100. In one example, a user profile may be associated with an email account and/or a social networking account. In one example, users database 108 may store one or more of a work location, a home location, preferred pick-up locations, preferred drop-off locations, commuting schedule information, vehicle information, whether the user is a driver, a rider, or both a driver and a rider, and feedback information associated with a user. User profile information may be populated by a user. Portions of user profile information may or may not be visible to other users. For example, a home location may be used by system 100 to determine a list of potential pick-up locations, but may not be visible to other users. Routes database 110 may store data associated with routes. For example, routes database 110 may include a list pick-up locations, drop-off locations, and schedule information.

Transaction site 112 and/or computing devices 102A-102N may use information included in places database 106, users database 108, and/or routes database 110 to facilitate ride-sharing transactions. In one example, graphical user interfaces presented by computing devices 102A-102N may including information included in places database 106, users database 108, and/or routes database 110. Such information may be presented in a manner to facilitate ride-sharing transactions, as described in further detail below.

As illustrated in FIG. 1, transaction site 112 is connected to communications network 104. Transaction site 112 may be configured to provide data to computing devices 102A-102N. In one example, computing devices 102A-102N may process information provided by transaction site 112 in a manner that enables a user of a computing device to view information associated with a ride-sharing transaction. In one example, transaction site 112 includes a server. In the example illustrated in FIG. 1, transaction site 112 includes application interface 114 and support engine 116. Application interface 114 and support engine 116 may be implemented as any of a variety of suitable circuitry, such as one or more microprocessors, digital signal processors (DSPs), application specific integrated circuits (ASICs), field programmable gate arrays (FPGAs), discrete logic, software, software modules, hardware, firmware or any combinations thereof.

In one example, application interface 114, support engine 116, and modules thereof may be implemented using one or more programming languages. Examples of programming languages include Hypertext Markup Language (HTML), Dynamic HTML, Extensible Markup Language (XML), Extensible Stylesheet Language (XSL), Document Style Semantics and Specification Language (DSSSL), Cascading Style Sheets (CSS), Synchronized Multimedia Integration Language (SMIL), Wireless Markup Language (WML), Java™, Jini™, Javascript, Node.js, restful API, C, C++, Pert, Python, UNIX Shell, Visual Basic or Visual Basic Script, Virtual Reality Markup Language (VRML), ColdFusion™ and other compilers, assemblers, and interpreters.

Application interface 114 may be configured to provide an interface between transaction site 112 and one or more of computing devices 102A-102N. For example, application interface 114 may provide one or more graphical user interfaces (GUIs) to computing devices 102A-102N. It should be noted that providing a graphical user interface to a computing device may include providing data to a computing device such that a computing device may generate a graphical user interface. Support engine 116 may be configured to support the operations of transaction site 112. For example support engine 116 may receive data from places database 106, users database 108, and/or routes database 110 and perform one or algorithms on data and provide the result of the algorithm to application interface 114. For example, support engine 116 may be configured to generate potential transactions for a user based on a user's location and the time the user desires a ride.

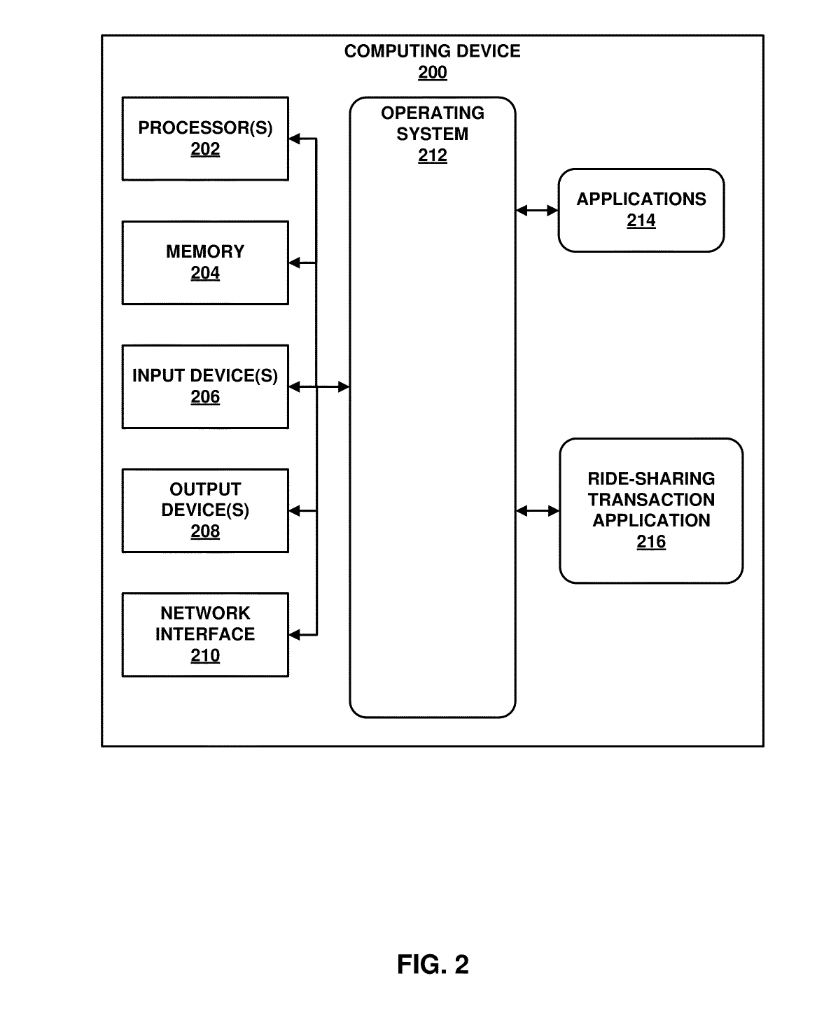

FIG. 2 is a block diagram illustrating an example of a computing device that may implement one or more techniques of this disclosure. Computing device 200 is an example of a computing device that may execute one or more applications, including ride-sharing transaction application 216. Computing device 200 may include or be part of a portable computing device (e.g., a mobile phone, netbook, laptop, personal data assistant (PDA), or tablet device) or a stationary computer (e.g., a desktop computer, or set-top box). Computing device 200 includes processor(s) 202, memory 204, input device(s) 206, output device(s) 208, and network interface 210.

Each of processor(s) 202, memory 204, input device(s) 206, output device(s) 208, and network interface 210 may be interconnected (physically, communicatively, and/or operatively) for inter-component communications. Operating system 212, applications 214, and ride-sharing transaction application 216 may be executable by computing device 200. It should be noted that although example computing device 200 is illustrated as having distinct functional blocks, such an illustration is for descriptive purposes and does not limit computing device 200 to a particular hardware architecture. Functions of computing device 200 may be realized using any combination of hardware, firmware and/or software implementations.

Processor(s) 202 may be configured to implement functionality and/or process instructions for execution in computing device 200. Processor(s) 202 may be capable of retrieving and processing instructions, code, and/or data structures for implementing one or more of the techniques described herein. Instructions may be stored on a computer readable medium, such as memory 204. Processor(s) 202 may be digital signal processors (DSPs), general purpose microprocessors, application specific integrated circuits (ASICs), field programmable logic arrays (FPGAs), or other equivalent integrated or discrete logic circuitry.

Memory 204 may be configured to store information that may be used by computing device 200 during operation. As described above, memory 204 may be used to store program instructions for execution by processor(s) 202 and may be used by software or applications running on computing device 200 to temporarily store information during program execution. For example, memory 204 may store instructions associated with operating system 212, applications 214, and ride-sharing transaction application 216 or components thereof, and/or memory 204 may store information associated with the execution of operating system 212, applications 214, and ride-sharing transaction application 216.

Memory 204 may be described as a non-transitory or tangible computer-readable storage medium. In some examples, memory 204 may provide temporary memory and/or long-term storage. In some examples, memory 204 or portions thereof may be described as volatile memory, i.e., in some cases memory 204 may not maintain stored contents when computing device 200 is powered down. Examples of volatile memories include random access memories (RAM), dynamic random access memories (DRAM), and static random access memories (SRAM). In some examples, memory 204 or portions thereof may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories.

Input device(s) 206 may be configured to receive input from a user operating computing device 200. Input from a user may be generated as part of a user running one or more software applications, such as ride-sharing transaction application 216. Input device(s) 206 may include a touch-sensitive screen, track pad, track point, mouse, a keyboard, a microphone, video camera, or any other type of device configured to receive input from a user.

Output device(s) 208 may be configured to provide output to a user operating computing device 200. Output may tactile, audio, or visual output generated as part of a user running one or more software applications, such as applications 214 and/or ride-sharing transaction application 216. Output device(s) 208 may include a touch-sensitive screen, sound card, a video graphics adapter card, or any other type of device for converting a signal into an appropriate form understandable to humans or machines. Additional examples of an output device(s) 208 may include a speaker, a cathode ray tube (CRT) monitor, a liquid crystal display (LCD), or any other type of device that can provide output to a user.

Network interface 210 may be configured to enable computing device 200 to communicate with external devices via one or more networks. Network interface 210 may be a network interface card, such as an Ethernet card, an optical transceiver, a radio frequency transceiver, or any other type of device that can send and receive information. Network interface 210 may be configured to operate according to one or more communication protocols.

Operating system 212 may be configured facilitate the interaction of applications, such as applications 214 and ride-sharing transaction application 216, with processor(s) 202, memory 204, input device(s) 206, output device(s) 208, network interface 210 and other hardware components of computing device 200. Operating system 212 may be an operating system designed to be installed on laptops and desktops. For example, operating system 212 may be a Windows operating system, Linux, or Mac OS. In another example, if computing device 200 is a mobile device, such as a smartphone or a tablet, operating system 212 may be one of an Android, an iOS or a Windows mobile operating system.

Applications 214 may be any applications implemented within or executed by computing device 200 and may be implemented or contained within, operable by, executed by, and/or be operatively/communicatively coupled to components of computing device 200, e.g., processor(s) 202, memory 204, and network interface 210. Applications 214 may include instructions that may cause processor(s) 202 of computing device 200 to perform particular functions. Applications 214 may include algorithms which are expressed in computer programming statements, such as, for loops, while-loops, if-statements, do-loops, etc.

Ride-sharing transaction application 216 may be an application that allows computing device 200 to perform functionality associated with system 100. In one example, ride-sharing transaction application 216 may be a web browser, such as, for example, Internet Explorer of Google Chrome and any associated supporting software modules (e.g., plugins). In one example, ride-sharing transaction application 216 may be a standalone application. It should be noted that techniques described herein may be performed by ride-sharing transaction application 216 and/or transaction site 112. It should be noted that the techniques described herein are not limited to a particular system architecture and may be realized using any combination of hardware, firmware and/or software implementations.

In one example, system 100 may include data structures for the origin and destination (e.g., home and work) of the commuters, which are distinct from the identified places to meet. That is, drivers and passengers may identify home and work locations and then pick several intermediate places on either end of their commute to meet for a ride. These places can be cafes, stores, transit stops or any other known type of landmark. Organizing carpooling around identified places has significant efficiencies, including, but not limited to the following: (1) Carpoolers can make concrete offers to drive and requests to ride between places. These offers can be made and accepted with no further negotiation. (2) Because places are known and publicly identified, there is no need for drivers to learn how to find a fellow carpoolers' work or home address. (3) Places offer a security advantage for carpoolers who have not met before. (4) Identified places allow for similar rides to be replicated between different carpools, which makes carpooling more scalable. For example, riders may know that if they go to a certain cafe, they can reliably get a ride to other known locations throughout the day. (5) By replicating similar rides between places, system 100 offers some redundancy. In the case where a driver cannot fulfill a ride as planned, another driver who has made a similar offer could substituted. (6) Because exact pick-up and drop-off are known as the shared commute is being planned, an exact distance-based price can be calculated in advance of the ride being requested. Identified places allow the users to make concrete, transactional requests to each other. Given that the two locations are already known to be agreeable to the driver and passenger, time and willingness to rideshare with the other party are the main factors that need consideration in order to complete a ride share transaction.

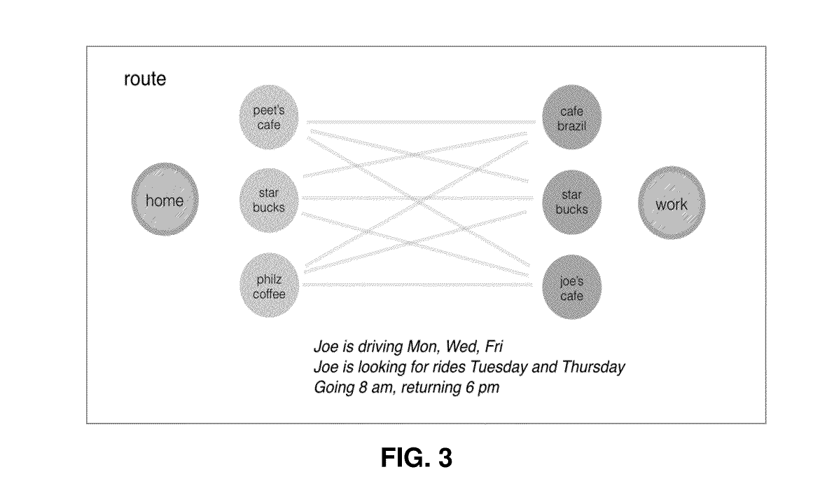

FIG. 3 is conceptual diagram illustrating potential transactions according to one or more techniques of this disclosure. FIG. 3 illustrates an example of a user (i.e., user Joe) selecting places close to the user's home, selecting places close to the user's work, providing schedule information, and routes being generated from the provided information. In the example illustrated in FIG. 3, three coffee shops located in proximity to a user's home are illustrated (peet's cafe, starbucks, and philz coffee) as selected and three coffee shops located in proximity to a user's work are illustrated (cafe brazil, starbucks, and joe's cafe) as selected. Further, as illustrated in FIG. 3, scheduling information is provided (i.e., user Joe is driving Monday, Wednesday, and Friday, and seeks a ride on Tuesday and Thursday). As further illustrated in FIG. 3, times associated with the user's commute are a leaving a home location time of 8:00 AM and a leaving a work location time of 6:00 PM. FIG. 3 illustrates routes between the three coffee shops located in proximity to the user's home and the three coffee shops located in proximity to the user's work that meet the schedule criteria. That is, for example, another user is offering a ride or seeking a ride based on the locations and schedule information. As described in detail below, graphical user interfaces may be presented to a user that enable a user to provide origin information, destination information, and schedule information and based on the provided information a list of potential routes may be presented to the user. A user may initiate and complete a ride transaction for a potential route.

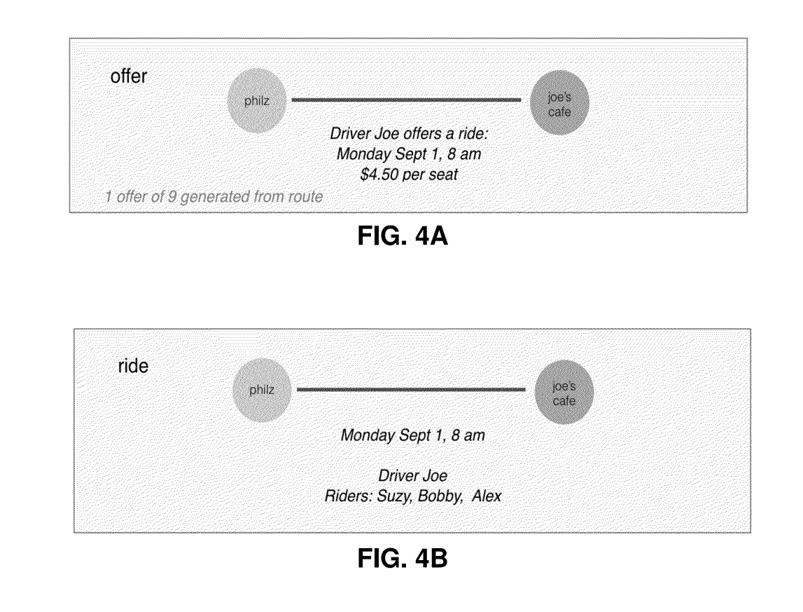

FIGS. 4A-4B are conceptual diagrams illustrating a transaction according to one or more techniques of this disclosure. In the example illustrated in FIGS. 4A-4B, a user (i.e., user Joe described above with respect to FIG. 3) offers to drive from a coffee shop located in proximity to the user's home (i.e., philz coffee) to a coffee shop located in proximity to the user's work (foe's cafe) at a 8:00 AM for a specified price. In one example, the specified price may include a price that is calculated based at least in part on a distance between two locations. In the example illustrated in FIGS. 4A-4B, three users (i.e., Suzy, Bobby, and Alex) accept the ride offer. In this manner, ride-sharing transactions may be facilitated by a user providing origin information, destination information, and schedule information.

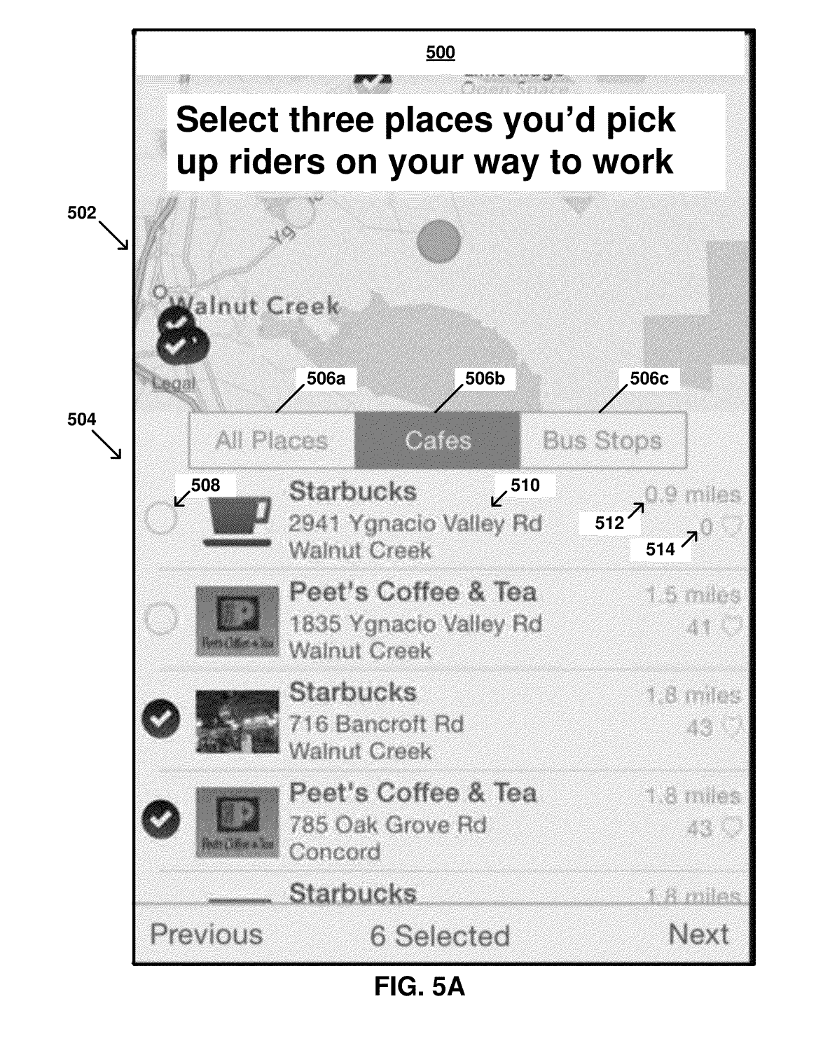

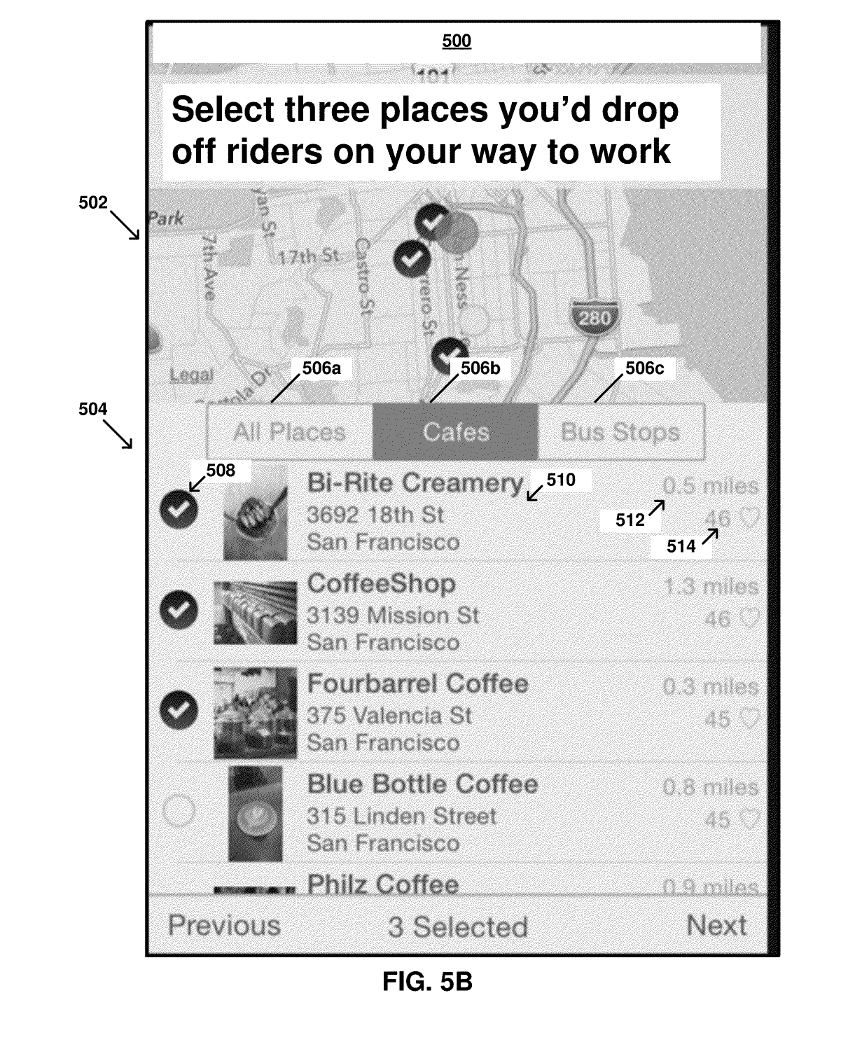

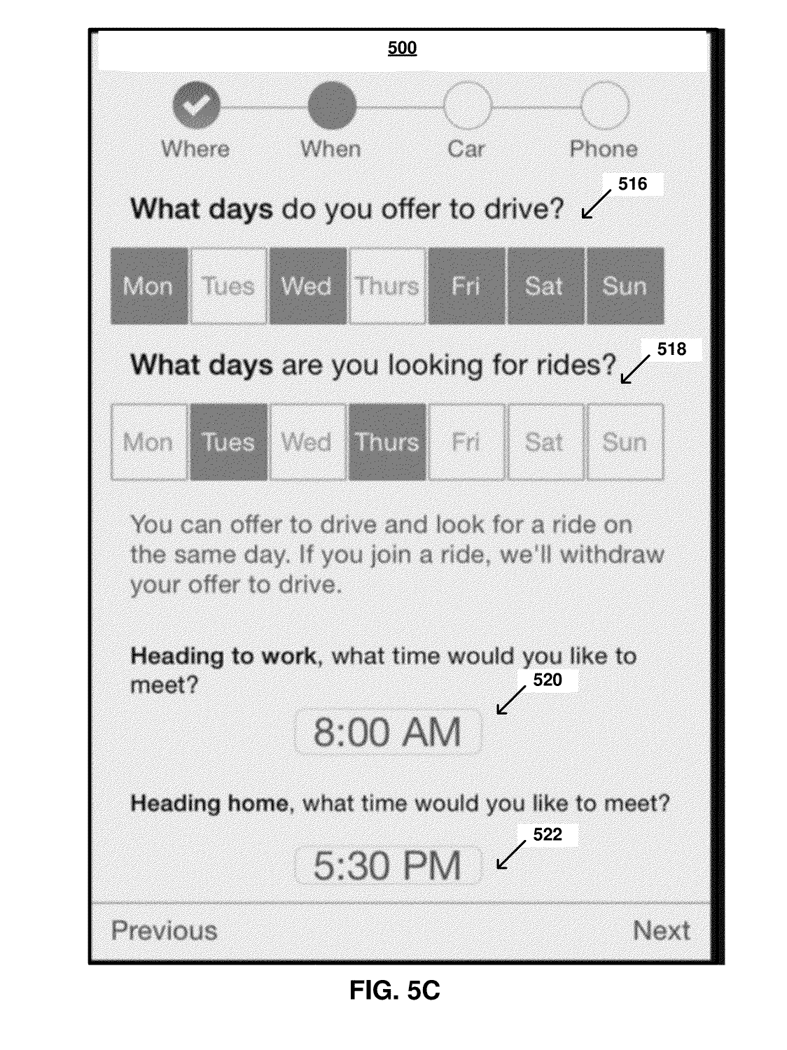

As described above, transaction site 112 and/or ride-sharing transaction application 216 may be configured to facilitate ride sharing transactions by providing one or more graphical user interfaces that enable a user to provide information and processing information provided by a user. Further, a user may accept or offer a ride using one or more graphical user interfaces provided by transaction site 112 and/or ride-sharing transaction application 216. FIGS. 5A-12D illustrate examples of graphical user interfaces that may be provided by transaction site 112 and/or ride-sharing transaction application 216 to facilitate ride-sharing transactions. In one example, graphical user interfaces may be presented on a display of a computing device (e.g., computing device 200).

FIGS. 5A-5C illustrate an example of a graphical user interface that enables a user to provide origin information, provide destination information, and provide schedule information. Graphical user interface 500 as illustrated in FIG. 5A represents an example of a graphical user interface that enables a user to provide origin information. As illustrated in FIG. 5A, graphical user interface 500 includes map 502, places list 504, and place type filters 506a-506c. Further, as illustrated in FIG. 5A for each place included in place list 504, a selection indicator 508, a description, including an address, 510, a distance from an origin 512, and a place rating 514 is included for the place. In the example illustrated in FIG. 5A, an origin (e.g., a user's home) is illustrated at the center of a map 502 and each selected place is illustrated on map 502 relative to origin. In one example, as described above, a user may provide an origin location while populating a user profile. In the example illustrated in FIG. 5A, a user may cause one or more places included in places list 504 to be displayed on map 502 by activating a respective selection indicator 508. For example, a user may touch a respective selection indicator presented on a touch screen to toggle the indicator between checked and unchecked.

In the example illustrated in FIG. 5A, a user may filter the types of places that are presented in places list 504 by selecting one of place type filters 506a-506c. In the example illustrated in FIG. 5A, user may cause all places (e.g., all places included in places database 106), cafes, or bus stops to be included in places list 504 by respectively activating one of 506a, 506b, and 506c. In other examples, places list may be filtered based on other types of places (e.g., shopping malls, retail centers, train stations, etc.). As illustrated in FIG. 5A, for each place included in list 508 a description 510 and a distance from an origin 512 are provided. As further illustrated in FIG. 5A, a place rating 514 is included for each place (e.g., a number of hearts). Place ratings may be based at least in part on feedback from other users. For example, as users pick favorite places and take rides from places, these choices may be tallied in system 100 and then ranked by system 100 so that the most popular places can be presented to other users of system 100. That is, system 100 may be configured such that matching places are ranked and sorted by popularity in the system in order to aggregate activity on the most popular places. Further system 100 may be configured such that drivers and passengers can pick the popular places and, if desired, places that are less popular, but more convenient. It should be noted that, as the number of users of system 100 grow, these secondary choices may offer sufficient liquidity for rides.

Graphical user interface 500 as illustrated in FIG. 5B represents an example of a graphical user interface that enables a user to provide destination information. As illustrated in FIG. 5B, graphical user interface 500 includes map 502, places list 504, and place type filters 506a-506c. Further, as illustrated in FIG. 5B for each place included in place list 504, a selection indicator 508, a description 510, a distance from an destination 512, and a place rating 514 is included for the place. In the example illustrated in FIG. 5B, a destination (e.g., a user's work) is illustrated at the center of a map 502 and each selected place is illustrated on map 502 relative to the destination. It should be noted that the terms origin and destination may refer to the same place depending on the direction of a route and role of a user. For example, a place by a user's home may be an origin on the way to work and a destination upon a return trip from work. In one example, as described above, a user may provide a destination location while populating a user profile. Each of map 502, places list 504, and place type filters 506a-506c is described above with respect to FIG. 5A.

In one example, after a user selects potential pick-up and drop-off places, a user may enter information about his or her commuting schedule. FIG. 5C illustrates an example of a graphical user interface that enables a user to provide schedule information, e.g., to select times when the user is willing to offer a ride and accept a ride. As described above, with respect to FIGS. 4A-4B based on a user's provided origin, destination, and schedule information, system 100 may generates offers to drive (and requests to ride) that are displayed to potential riders and drivers. As illustrated in FIG. 5C, graphical user interface 500 includes an offer to drive schedule selector 516, looking for a ride schedule selector 518, heading to work time selector 520, and heading home time selector 522. In the example, illustrated in FIG. 5C, a user may cause one or more days of the week to be selected by activating respective days using offer to drive schedule selector 516 and/or looking for a ride schedule selector 518. Further, heading to work time selector 520 and a heading home time selector 522 may be configured to enable a user to enter times.

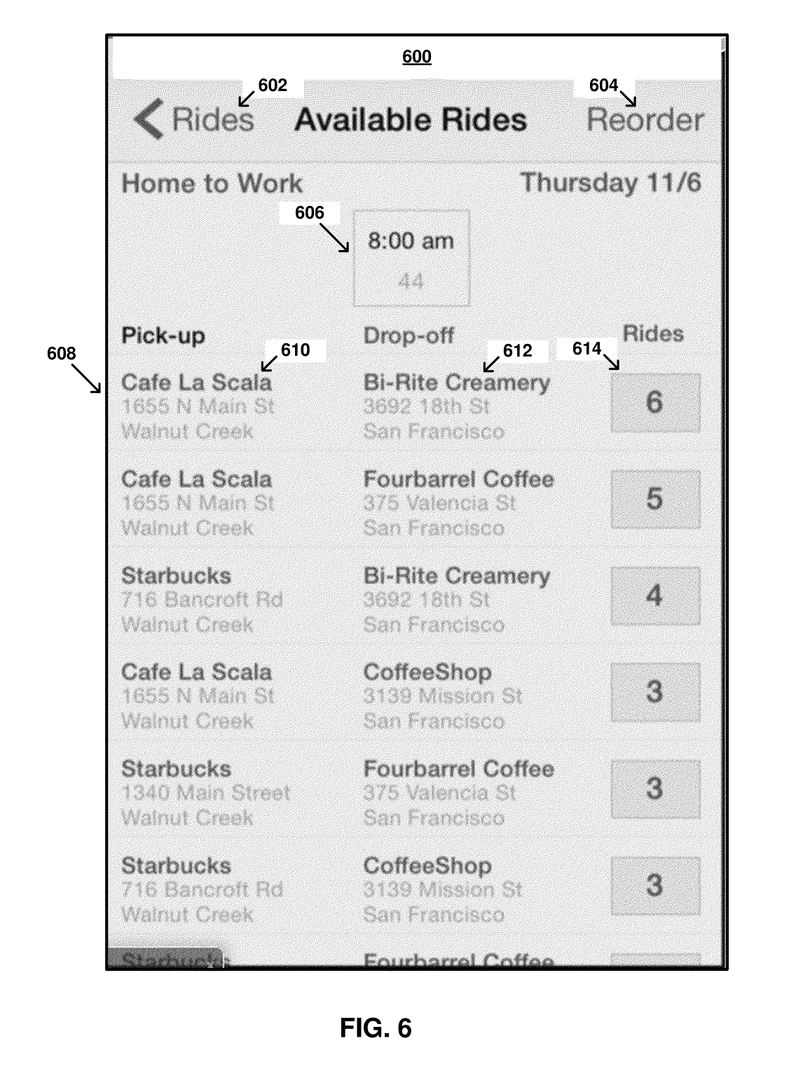

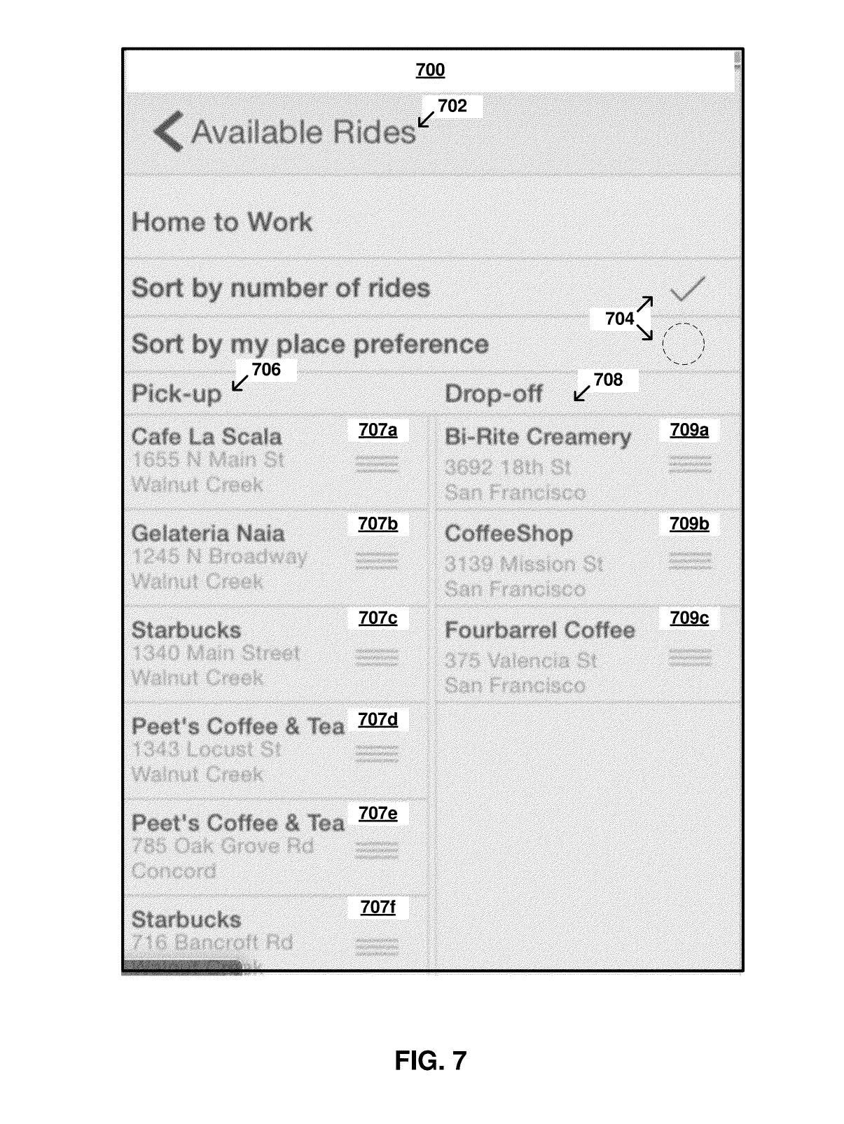

As described above, upon a user providing origin information, destination information, schedule information, a list of potential routes may be presented to the user. FIG. 6 represents an example of a graphical user interface provided to a user in order for a user to view potential routes. Graphic user 600 includes back to rides icon 602 and reorder icon 604. Back to rides icon 602 may cause graphical user interface 500 to be presented (e.g., in the event a user wishes to change provided information based on the potential routes). Reorder icon 604 may cause graphical user interface 700 described with respect to FIG. 7 to be presented which may enable a user to change the order in which potential rides are presented in graphical user interface 600. Referring again to FIG. 6, graphical user interface 600 includes time and total number of potential routes indicator 606 and list of potential routes 608. Time and total number of potential routes indicator 606 provides the user an indication of the number of other users respectively offering or seeking a ride at the indicated time, which may be referred to as a number of interested users. It should be noted that in some examples time and total number of potential routes indicator 606 may include a range of times. For examples, users may offer rides at 8:00 AM, 8:15 AM, and 8:30 AM, a user seeking a ride may wish to view rides offered at each of these times. List of potential routes 608 one or more potential routes based on information provided by a user. For each potential route included in list of potential routes 608, origin description 610, a destination description 612, and a number of users interested users 614. Origin description 610 and destination description 612 may include a place name. As described in further detail below a user may select a potential route from list of potential routes 608 and graphical user interfaces that further enable a user to facilitate a ride-sharing transaction may be presented.

In the example illustrated in FIG. 6, rides in list of potential rides 608 are sorted by availability i.e., number offered. Having the most popular places/rides at the top of the list promotes the aggregation of similar rides at popular places by system 100. It should be noted that less popular, but potentially more convenient combinations of places are also exposed in system 100, in case they represent a better fit for the user. In other examples, a user may choose to sort rides according to another parameter. FIG. 7 illustrates an example of a graphical user interface that enables a user to select how rides are sorted. That is, graphical user interface 700 enables users to override the promotion of popular places by optionally ordering places to meet by user preference. In this manner, place combinations, less popular, but more preferred by the user are elevated in the system. Graphical user interface 700 includes available rides icon 702 which upon activation, causes graphical user interface 600 to be presented. Graphical user interface 700 further includes sort selector 704, origin preference list 706, and destination preferences list 708. In the example illustrated in FIG. 7, sort selector 704 enables a user to select whether potential routes in list of potential routes 608 are sorted primarily based on the number of interested users or by the particular user's preference. It should be noted that in other examples, places may be sorted based on one or more of proximity to a user provided location (e.g., a home address), popularity, and/or user preferences. As illustrated in FIG. 7, origin preference list 706 includes places 707a-707f and destination preferences list 708 includes 709a-709c. In one example, a user may “move” (e.g., using a drag-and-drop operation) places near the top of origin preference list 706 or destination preferences list 708 to indicate a higher preference. In this manner, graphical user interface 700 may enable a user to sort the list of routes based on a number of available rides or a place preference.

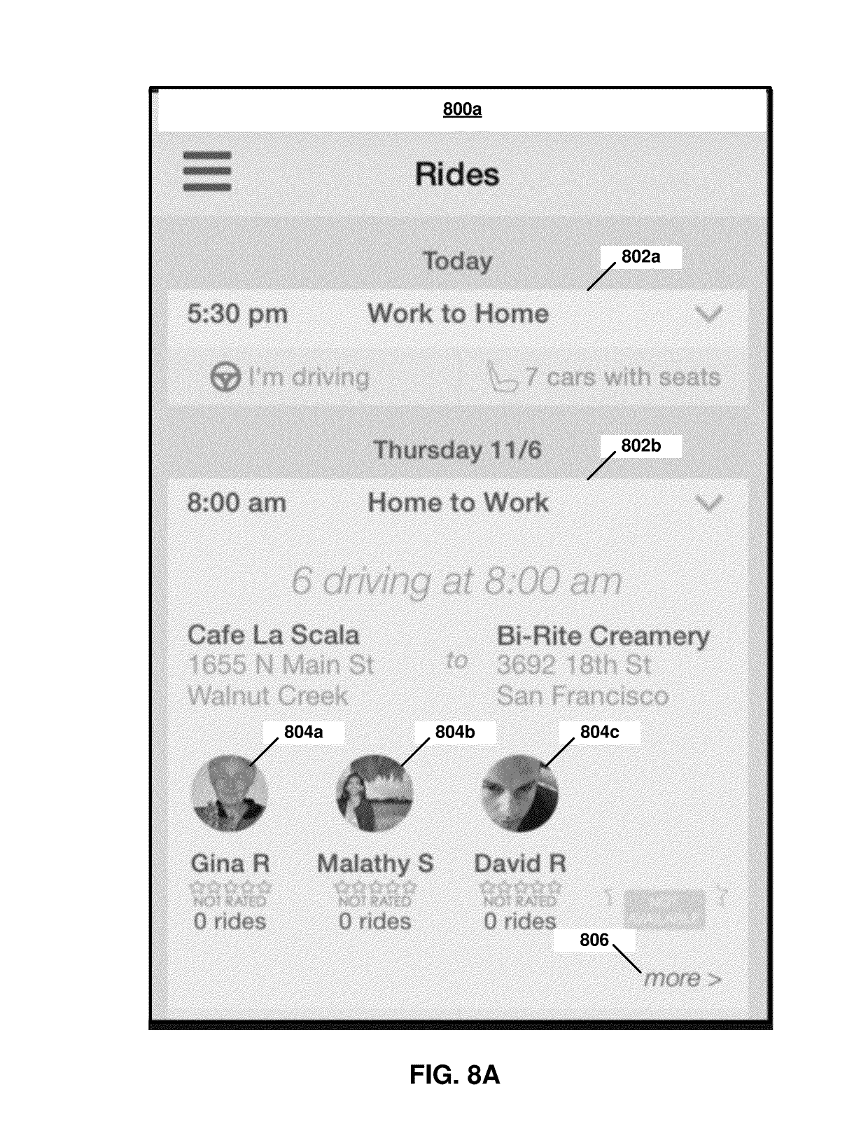

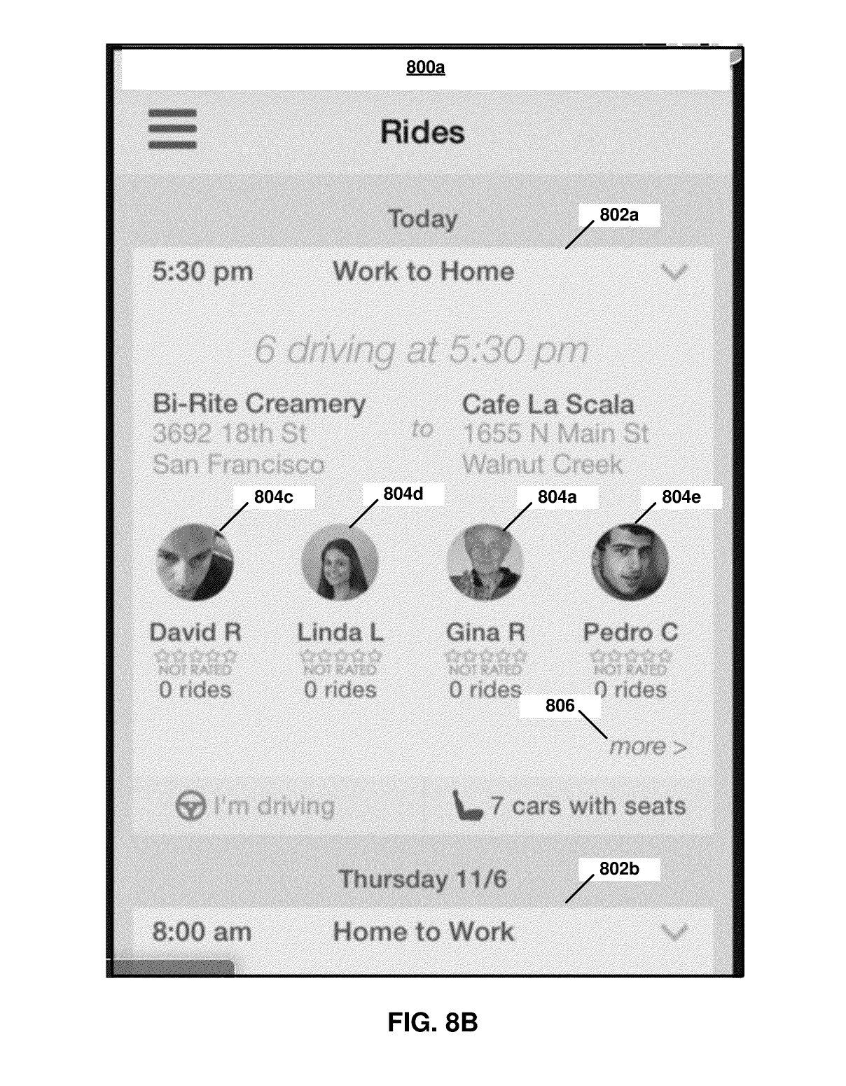

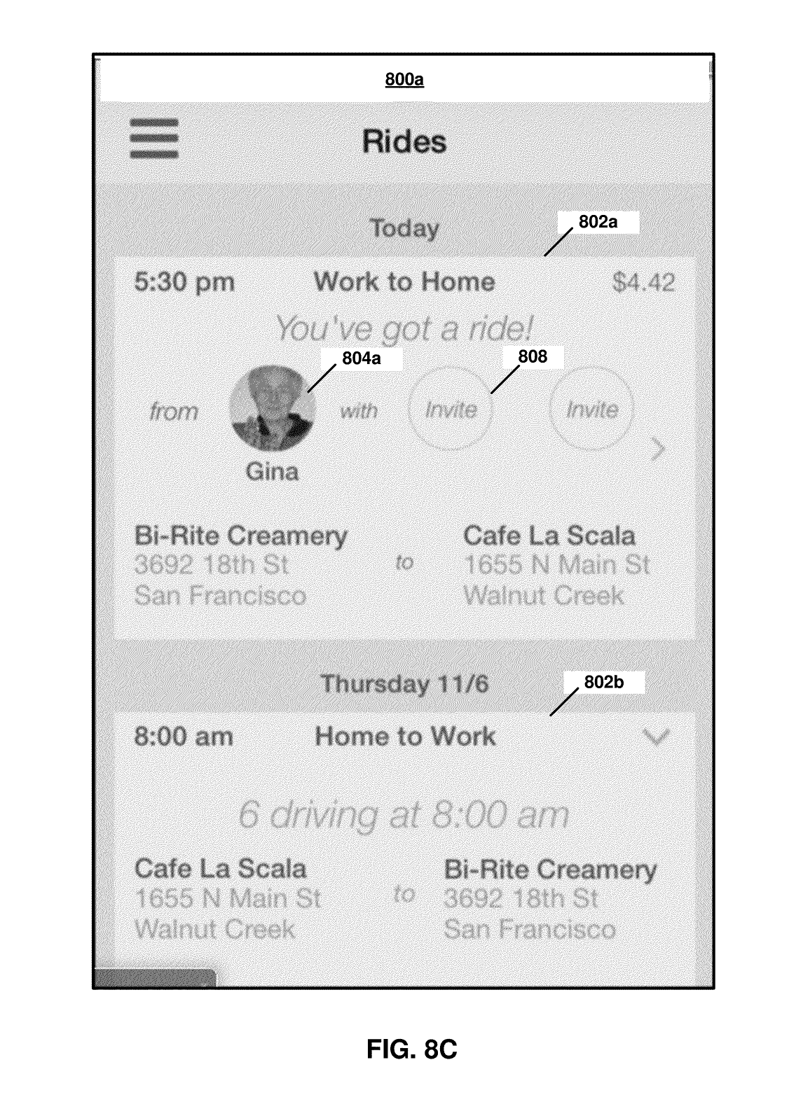

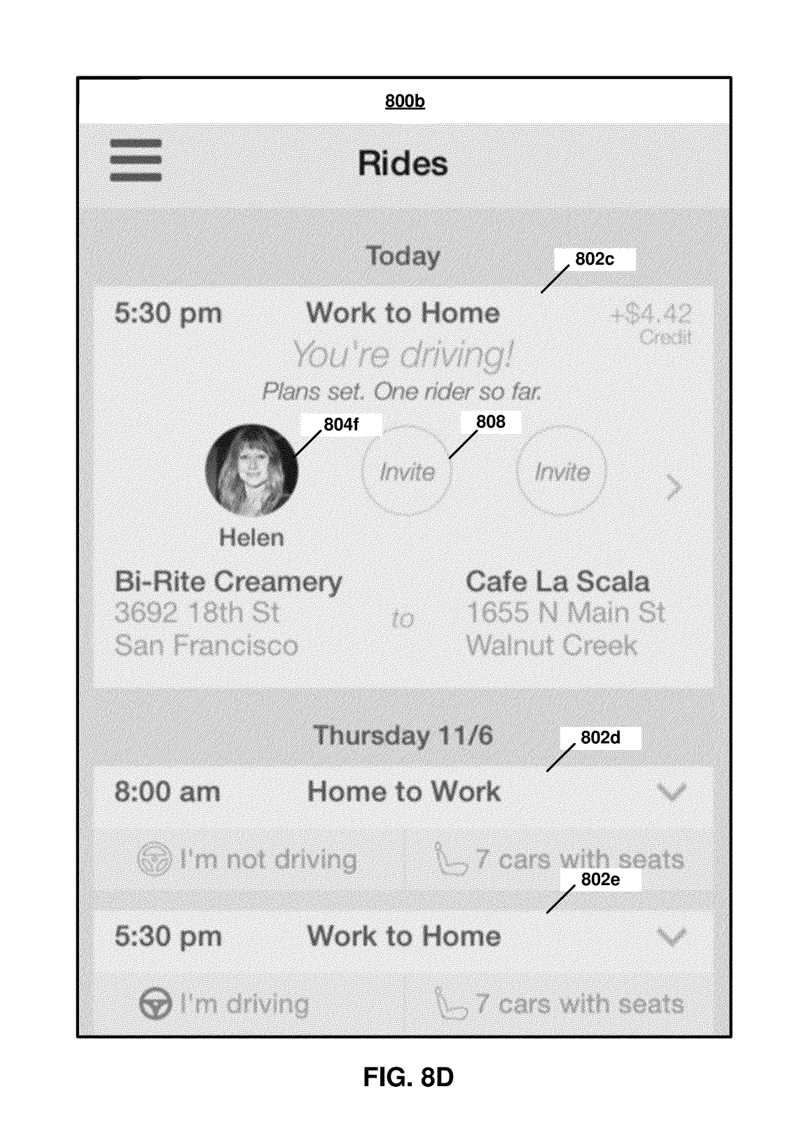

As described above, a user may select a potential route (e.g., from list of potential routes 608) and graphical user interfaces that further enable a user to facilitate a ride-sharing transaction may be presented. Once a user selects a potential route, e.g., using the graphical user interface 600 illustrated in FIG. 6, a graphical user interface illustrating potential drivers or passengers may be displayed. FIGS. 8A-10 illustrate examples of graphical user interfaces that enable users to complete a ride-sharing transaction. Referring to FIGS. 8A-8D, graphical user interfaces 800a-800b includes potential routes 802a-802e associated with a particular time, an origin, and a destination. It should be noted that graphical user interfaces 800a and 800b show the same example ride-sharing transaction, where graphical user interface 800a shows the transaction from the rider's (i.e., user Helen P's) perspective and graphical user interface 800b shows the example ride-sharing transaction from the driver's (i.e., user Gina R's) perspective. As illustrated in FIGS. 8A-8D, potential routes 802a-802e may be presented in a summarized view or an expanded view. Referring to FIG. 8A, potential route 802b is presented in an expanded view and as such, user icons 804a-804c associated with potential route 802b are displayed. Referring to FIG. 8B, potential route 802a is presented in an expanded view and as such, user icons 804a, 804c, 804d, and 804e associated with potential route 802a are displayed. In the example illustrated in FIGS. 8A-8B, a user may scroll down in order to arrange for rides according to a user's schedule information. For example, a user may enter a schedule for the week and fill the schedule using graphical user interface 800a. In the examples illustrated in FIGS. 8A-8B, user icons 804a-804e are associated with user's offering a ride. Further, upon activation, more icon 806 may cause more user icons to be displayed. As illustrated in FIGS. 8A-8B, each of the potential drivers are associated with a rating and a number of ride that they have given.

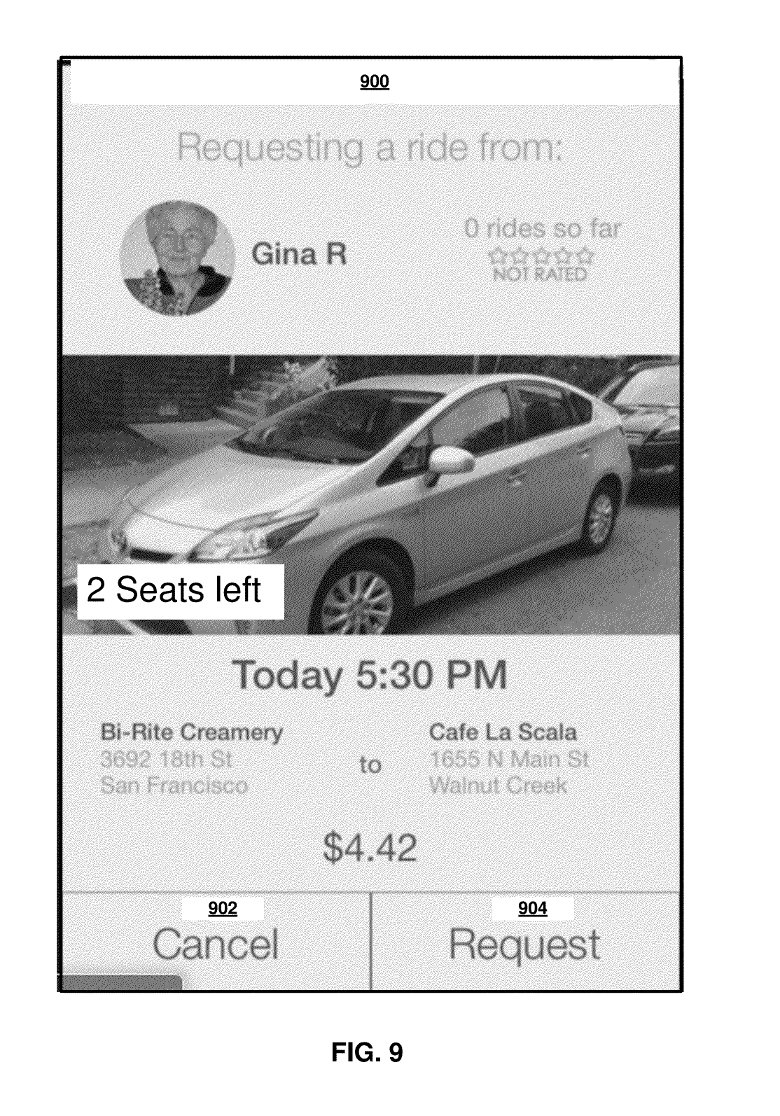

FIGS. 8C-8D illustrate examples from respective rider and driver perspectives where a user has accepted a ride. FIGS. 8C-8D illustrate respective graphical user interfaces that may be displayed to a driver and a passenger to confirm that a ride offer has been accepted. As illustrated in FIGS. 8C-8D the confirmation information may be integrated in a graphical user interface displaying a commuting schedule. Further, as illustrated in FIGS. 8C-8D, once a user has accepted a ride, invite icon 808 may be displayed for a potential route. That is, upon activation invite icon 808 may enable a passenger or a driver to invite another user to join a particular ride. For example, a use may invite a co-worker that lives nearby to join an accepted ride. Referring to FIG. 8B, a user may review each of the drivers for potential route 802a and request a ride from a driver by activating the particular user icon. FIG. 9 illustrates an example of a graphical user interface that may be presented upon a user activating a user icon. Graphical user interface 900 represents an example where a user selects user icon 804a from graphical user interface 800a illustrated in FIG. 8B.

As illustrated in FIG. 9, graphical user interface 900 includes more information about the driver. In the example illustrated in FIG. 9, graphical user interface 900 includes a picture of the driver's vehicle, price information, and a number of remain sets for a ride. In one example, price information may be pre-calculated by system 100, that is all rides in the system may be calculated by formulas (e.g., distance, rating, vehicle quality, number of seats offered/available, etc.) defined by system 100. In other examples, a driver may provide a price for a particular ride. When an agreeable offer to drive is found, a user can make a request for a ride from a driver by, for example, tapping request icon 904 illustrated in FIG. 9. Further, if the user finds the ride conditions unacceptable (e.g., price to high, vehicle unacceptable, etc.), a user may activate cancel icon 902 to cause graphical user interface 800a to be presented. A user may continue this process of reviewing detailed user information until a user finds an acceptable ride at which point a user may request a ride.

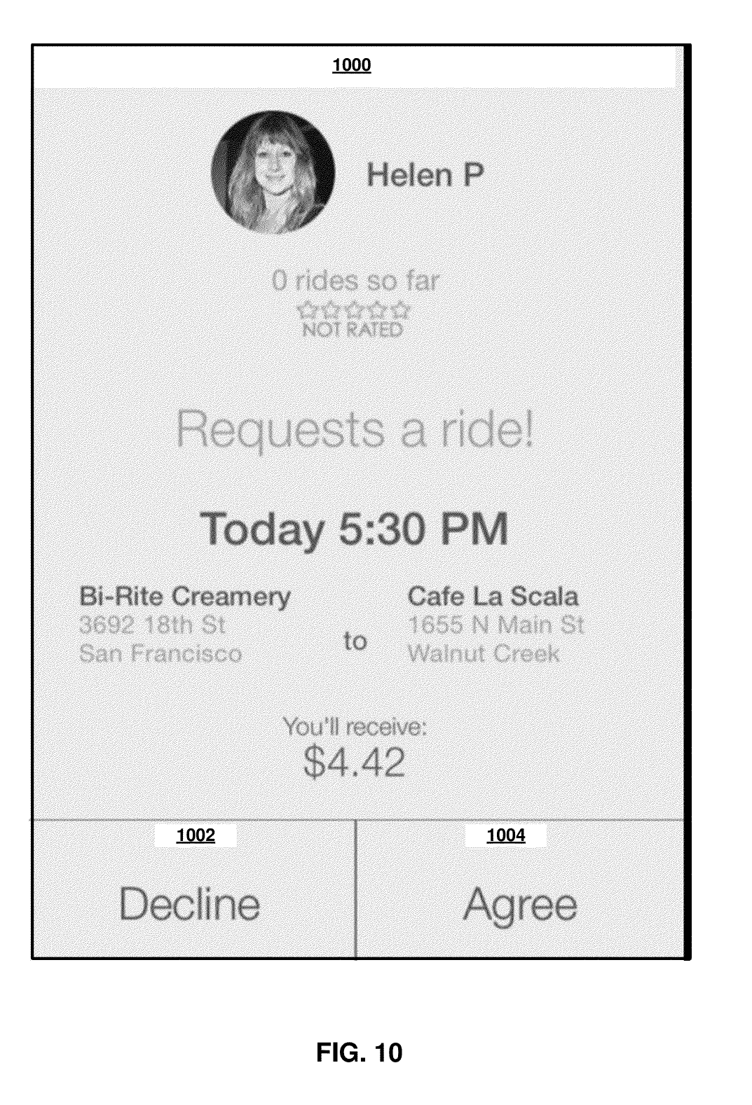

In the examples illustrated in FIGS. 9-10, upon a user requesting a ride, a driver may be presented with a graphical user interface that enables the driver to respond to requests for rides. FIG. 10 illustrates an example of a graphical user interface that may be presented to a driver when a ride is requested of the driver. As illustrated in FIG. 10, graphical user interface 1000 includes information about the user requesting a ride, route and pricing information, and includes decline icon 1002 and agree icon 1004. Decline icon 1002 and agree icon 1004 respectively enable a driver to accept or decline an offer for a ride. It should be noted that although amounts a rider pays and the driver receives match in FIGS. 9 and 10, in some examples the amounts may be different. That is, in some cases, the driver may receive less than the user pays and the excess amount may be received by the manager of system 100.

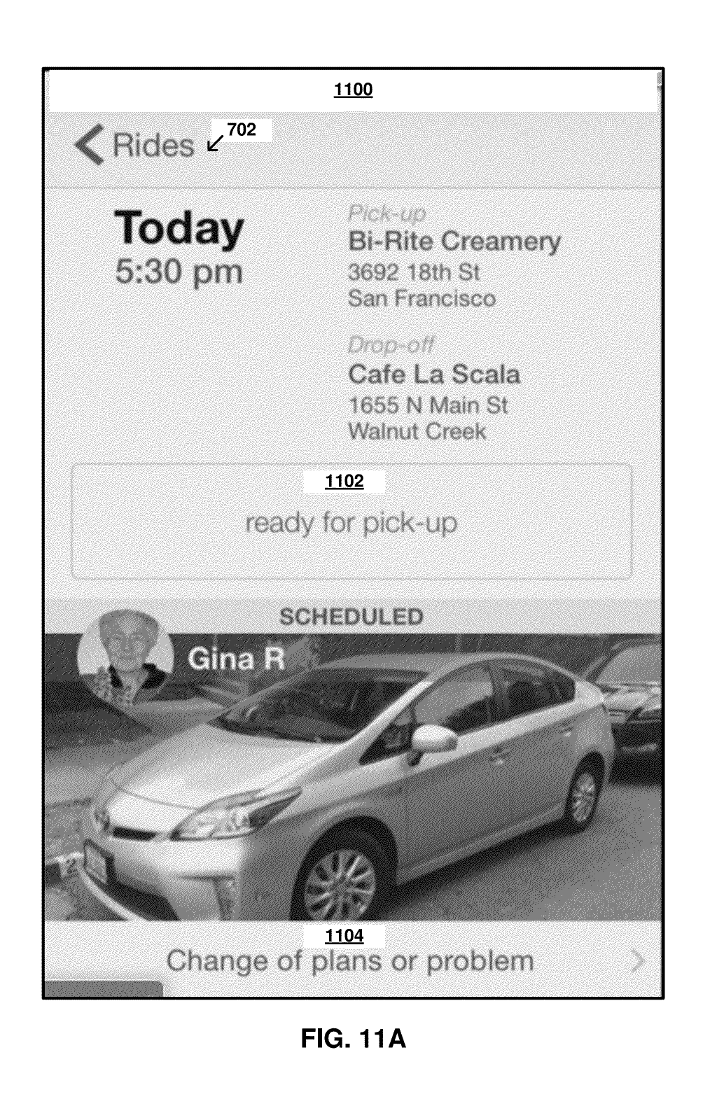

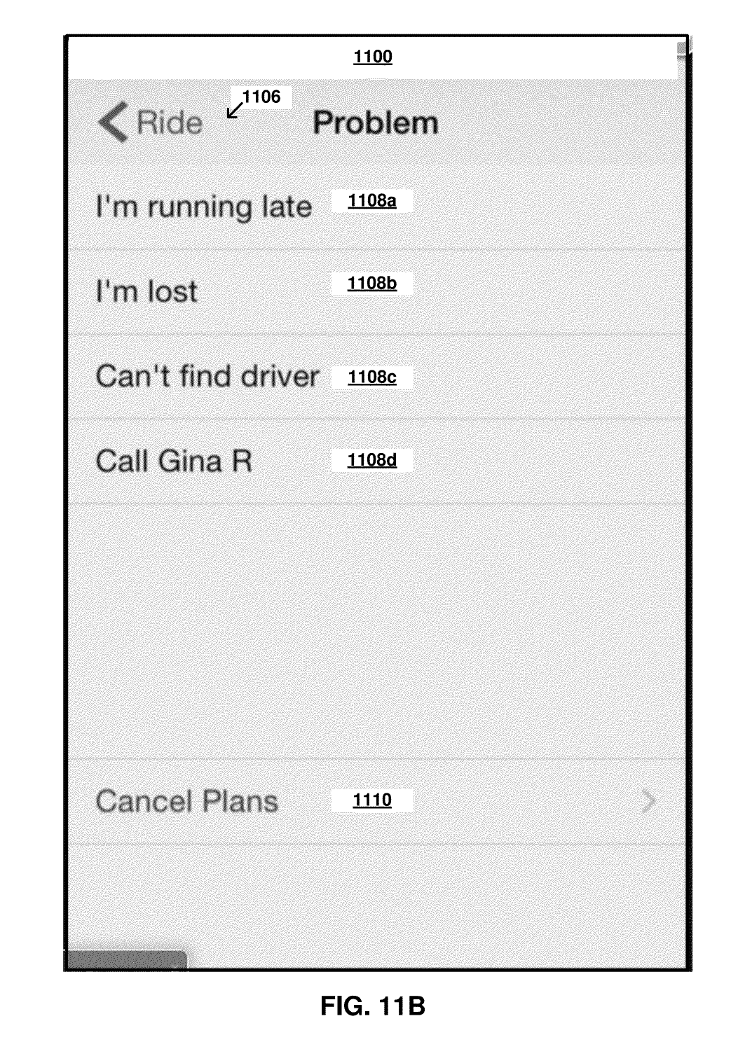

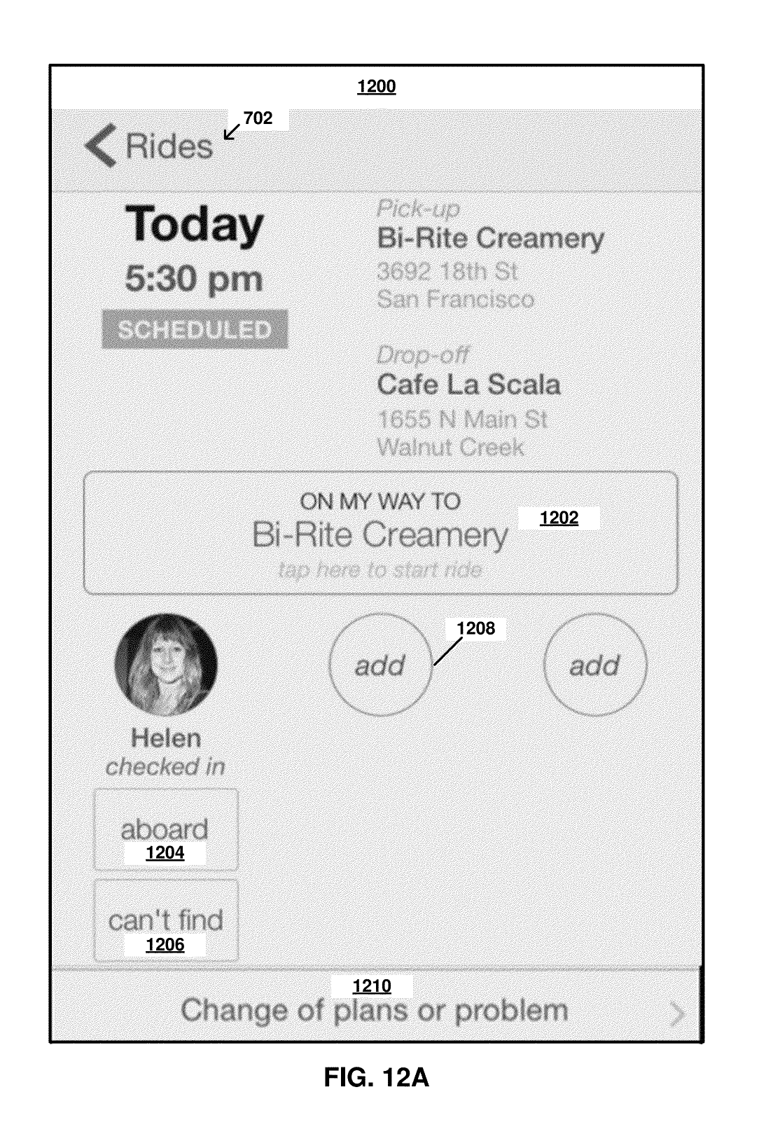

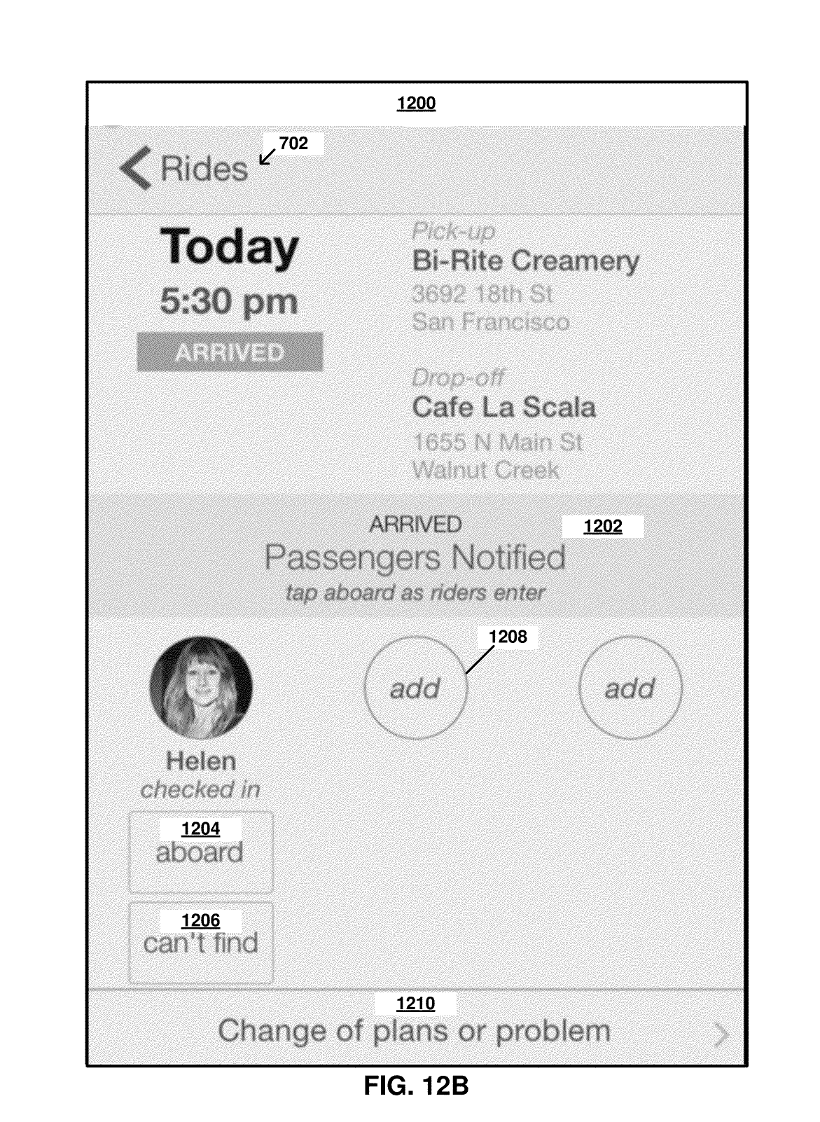

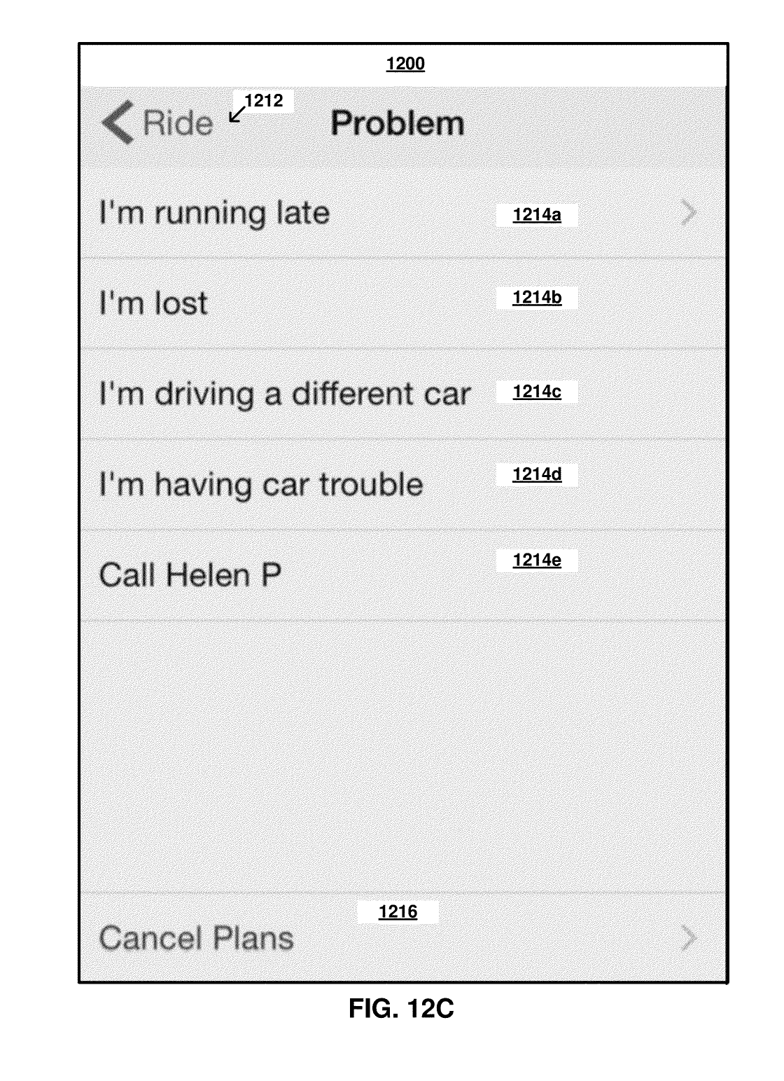

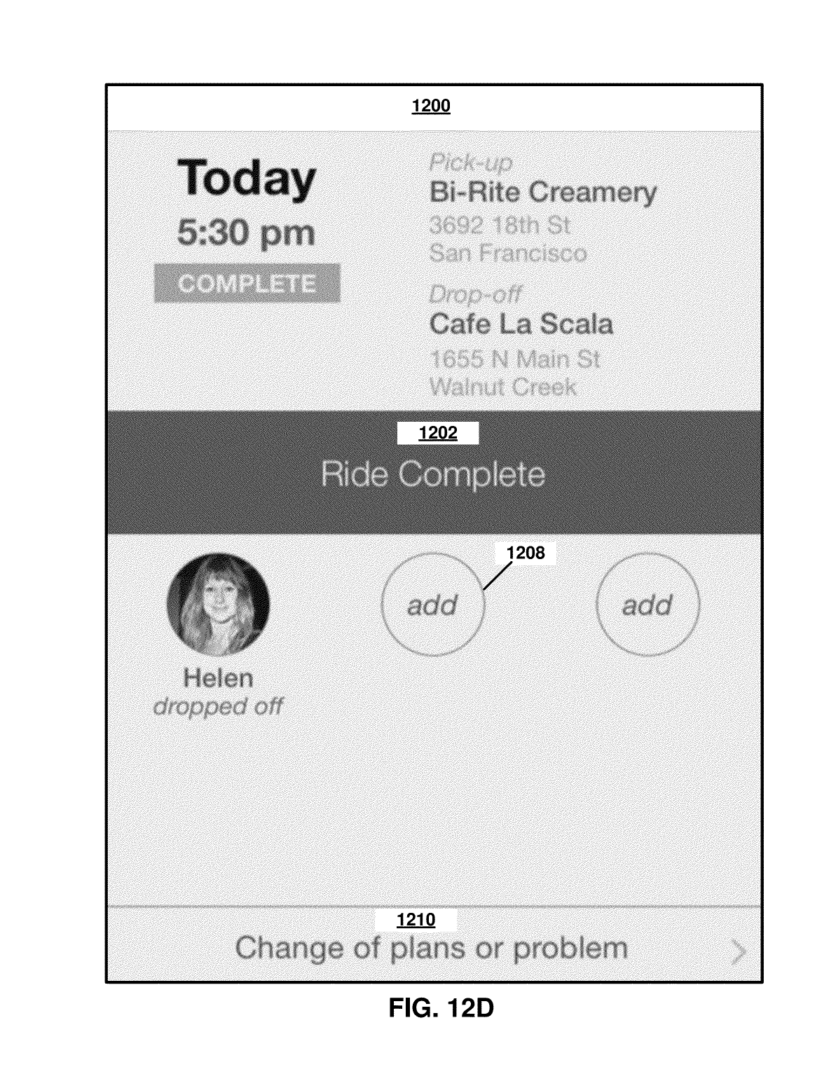

In addition to enabling users to arrange rides, system 100 may enable users to confirm ride logistics. FIGS. 11A-12D illustrate example graphical user interfaces that may respectively enable a passenger and a driver to confirm statuses. Graphical user interface 1100 illustrated in FIGS. 11A-11C, enable a rider to indicate that he or she is ready for pick-up or is experiencing a problem. Graphical user interface 1100 as illustrated in FIG. 11A includes ready for pick-up icon 1102 and change of plans or problem icon 1104. Upon activation of ready for pick-up icon 1102, a driver may be notified (e.g., through graphical user interface 1200) that a passenger is ready for pick-up at an origin. Upon activation of change of plans or problem icon 1104, graphical user interface 1100 as illustrated in FIG. 11B may be presented to a user. Graphical user interface 1100 as illustrated in FIG. 11B includes ride icon 1106, communication icons 1108a-1108c, and cancel plans icon 1110. Ride icon 1106 may cause graphical user interface 1100 as illustrated in FIG. 11B to be presented. Upon activation of one of respective communication icons 1108a-1108c a respective message may be sent to a driver. In the example illustrated in FIG. 11B, upon activation of icon 1108d a telephone call may be initiated between a passenger and a driver. In one example, system 100 may enable virtual calls. That is, the driver and passenger may be able to engage in a call without knowing the phone number of the other. In the example illustrated in FIG. 11B, upon activation of cancel plans icon 1110, a passenger may indicate that he or she no longer desires a ride.

Graphical user interface 1200 illustrated in FIGS. 12A-12D, enable a driver to indicate the driver's status with respect to the pick-up place (e.g. on their way to the pick-up place). As illustrated in FIGS. 12A-12D, graphical user interface 1200 displays the status of the passenger (e.g., not checked-in, checked-in, in route, dropped off, etc.). Further, as illustrated in FIGS. 12A-12D graphical user interface 1200 includes driver status indicator 1202, aboard icon 1204, can't find icon 1206, add rider icon 1208, change of plans or problem icon 1210, ride icon 1212, communication icons 1214a-1214e, and cancel plans icon 1216. Driver status indicator 1202 enables a driver to indicate his or her status with respect to a ride. Referring to FIG. 12A, a driver may activate icon 1202 to indicate that he or she is on their way to an origin. Referring to FIG. 12B, a driver may activate driver status icon 1202 to indicate that he or she has arrived at the origin. Referring to FIG. 12D, a driver may activate driver status icon 1202 to indicate that he or she has completed a rider (i.e., arrived at the destination and dropped off a passenger).

Referring to FIG. 12B, upon a driver arriving at an origin, the driver may indicate whether a passenger is aboard the vehicle by activating icon 1204 or whether the drive cannot find the passenger by activating icon 1206. Further, once a driver arrives at an origin additional riders may wish to join the ride. Add rider icon 1208 enables a driver to add riders to the ride and in this manner receive credit for transporting the rider by system 100. Further, graphical user interface 1200 includes change of plans or problem icon 1210 which upon activation causes graphical user interface 1200 as illustrated in FIG. 12C to be presented. Similar to graphical user interface 1100 as described above with respect to FIG. 11B, communication icons 1214a-1214e enable a respective message to be sent to a rider or a phone call to be initiated and cancel plans icon 1216 enables a driver to cancel the trip. Upon activation, ride icon 1212 may cause graphical user interface 1200 as illustrated in FIG. 12B to be presented. In this manner, graphical user interfaces illustrated in FIGS. 11A-12D, enable each of the driver and passenger to indicate if a problem is encountered or if ride transaction is successful. Although not shown, upon a ride being completed, graphical user interfaces that enable users to rate one another may be presented. In this manner, system 100 represents an example of system configured to facilitate transportation transactions.

It should be noted that the place-based scheme described herein may not be solely used to find individuals who match, but may also capture the willingness of drivers to pick up passengers on given routes and to find the places which will be popular for drivers and passengers in an area. Capturing aggregate user preferences across many places and then promoting popular places to users in any locality may allow example systems to be self-organizing. By systemizing the willingness to drive and choices about where to meet, example systems may enable the crowd to promote places that are most popular and optimal for carpooling without the need for experts to pick these locations. As users pick preferred places and ride from places, this information may be used to rank the places globally in the system. These places may also be compared to other places within given localities. That information may help an example system become increasingly better at suggesting places to meet based solely on user activity. These example self-organizing aspects of a system may allow a system to enable the crowd of users to make routing decisions as if it were a transit agency planning bus-stops solely from user interaction. So, for example, in the cases where a mass transit system is disabled due to strike or disaster, drivers and riders using an example system described herein would automatically identify and promote the most convenient places to meet for rides between users, such that the transportation load could be carried by the empty seat in cars without the need for transportation planners to research and plan the system, i.e., it will organize itself organically directly in response to usage.

Further, it should be noted that by allowing drivers and riders to pick multiple places to pick-up and drop-off people, the system's processes allow drivers and riders to make multiple offers to drive and requests for rides across several locations. Those offers and requests may then be presented to other potential users. For example, passengers can pick the combination of places that is most convenient and respond to the offer to drive that is most convenient. So for example, a driver can picks three places on a route, A, B and C, to pick riders up and three places, D, E and F, to drop riders off. An example system may generate nine offers based on these selections with the following combinations of pick-ups and drop-offs: AD, AE, AF, BD, BE, BF, CD, CE, CF. These offers may be presented to passengers who also stated their preferred pick-up and drop-off locations. In one example, a passenger who picked BD and BF will be presented those offers and get to pick between them. For example, if the passenger picks BD, a request is sent to the driver and if the driver agrees to provide the ride, assuming the driver is only offering one pick-up on the route the other offers are instantly withdrawn. In one example, in order for a system to handle these offers across many places at once, processes are included in system 100 to allow the first rider responding to offers to drive to determine the actual route and stops the driver will take. This is accomplished through a near-real time messaging system. The first passenger who responds to an offer, presents a request to the driver that if agreeable may determine the pick-up and drop-off place for the driver. Once the driver agrees to provide the ride, other offers to drive may be instantly withdrawn for all riders accessing the system. Other passengers can then join the trip as planned by the driver and the first rider. It should be noted that other offers are also possible. For example, other passengers may join other trips.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of facilitating a transportation transaction, the method comprising:
providing a graphical user interface enabling a user to provide origin information;
providing a graphical user interface enabling a user to provide destination information;
providing a graphical user interface enabling a user to provide schedule information; and
providing a graphical user interface including a list of routes based on origin information, destination information, and schedule information, wherein each of the routes are associated with a number of available rides.

2. The method of claim 1, wherein the graphical user interface enabling a user to provide origin information enables the user to select places of a particular type in proximity to a location.

3. The method of claim 2, wherein the graphical user interface enabling a user to provide destination information enables the user to select places of a particular type in proximity to a location.

4. The method of claim 1, wherein the graphical user interface enabling a user to provide schedule information enables the user to indicate whether for each particular day of a week whether the user desires to offer to drive or desires to join a ride.

5. The method of claim 1, further comprising providing a graphical user interface enabling a user to sort the list of routes based on a number of available rides or a place preference.

6. The method of claim 1, further comprising providing a graphical user interface enabling a user to engage in a transportation transaction, wherein the graphical user interface includes profile information for each user offering to provide a ride for a route.

7. The method of claim 6, wherein the graphical user interface enabling a user to engage in a transportation transaction includes icons for each user offering to provide a ride for a route which upon activation enable the user to request a ride.

8. A device comprising one or more processors configured to:
provide a graphical user interface enabling a user to provide origin information;
provide a graphical user interface enabling a user to provide destination information;
provide a graphical user interface enabling a user to provide schedule information; and
provide a graphical user interface including a list of routes based on origin information, destination information and schedule information, wherein each of the routes are associated with a number of available rides.

9. The device of claim 8, wherein the graphical user interface enabling a user to provide origin information enables the user to select places of a particular type in proximity to a location.

10. The device of claim 9, wherein the graphical user interface enabling a user to provide destination information enables the user to select places of a particular type in proximity to a location.

11. The device of claim 8, wherein the graphical user interface enabling a user to provide schedule information enables the user to indicate whether for each particular day of a week whether the user desires to offer to drive or desires to join a ride.

12. The device of claim 8, further comprising providing a graphical user interface enabling a user to sort the list of routes based on a number of available rides or a place preference.

13. The device of claim 8, wherein the one or more processors are further configured to provide a graphical user interface enabling a user to engage in a transportation transaction, wherein the graphical user interface includes profile information for each user offering to provide a ride for a route.

14. The device of claim 13, wherein the graphical user interface enabling a user to engage in a transportation transaction includes icons for each user offering to provide a ride for a route which upon activation enable the user to request a ride.

15. A non-transitory computer-readable storage medium having instructions stored thereon that upon execution cause one or more processors of a device to:
provide a graphical user interface enabling a user to provide origin information;
provide a graphical user interface enabling a user to provide destination information;
provide a graphical user interface enabling a user to provide schedule information; and
provide a graphical user interface including a list of routes based on origin information, destination information and schedule information, wherein each of the routes are associated with a number of available rides.

16. The non-transitory computer-readable storage medium of claim 15, wherein the graphical user interface enabling a user to provide origin information enables the user to select places of a particular type in proximity to a location.

17. The non-transitory computer-readable storage medium of claim 16, wherein the graphical user interface enabling a user to provide destination information enables the user to select places of a particular type in proximity to a location.

18. The non-transitory computer-readable storage medium of claim 15, wherein the graphical user interface enabling a user to provide schedule information enables the user to indicate whether for each particular day of a week whether the user desires to offer to drive or desires to join a ride.

19. The non-transitory computer-readable storage medium of claim 15, further comprising providing a graphical user interface enabling a user to sort the list of routes based on a number of available rides or a place preference.

20. The non-transitory computer-readable storage medium of claim 15, wherein the one or more processors are further configured to provide a graphical user interface enabling a user to engage in a transportation transaction, wherein the graphical user interface includes profile information for each user offering to provide a ride for a route.
